(19) United States
(12) Patent Application Publication
(10) Pub. No.: US 2007/0124309 A1
(43) Pub. Date: May 31, 2007

(54) Content retrieval system

(75) Inventors: Masaaki Takase, Kawasaki (JP); Mitsuaki Kakemizu, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/355,343

(22) Filed: Feb. 16, 2006

(30) Foreign Application Priority Data
Nov. 4, 2005 (JP) 2005-321601

(51) Int. Cl. G06F 17/30; G06F 7/00

(52) U.S. Cl. 707/10

(57) ABSTRACT

In a content retrieval system where an update frequency of content is extremely high, based on a content reference request from a client which generates the content reference request including unique information and an attribute of a desired content, a cache server checks a presence/absence of a cache of the content, caches the content from a content server to transmit the content to the client in the absence of the cache of the content, or transmits the content held to the client in the presence of the cache of the content. Then, the cache server performs synchronization mirroring with the content server based on the attribute.

### BACKGROUND OF THE INVENTION

1. Field of the Invention

The present invention relates to a content retrieval system, and in particular to a system retrieving content by using a cache from a network.

2. Description of the Related Art

As technologies for reducing traffic flowing over a network, (1) a cache technology and (2) a mirroring technology exist. Both serve to copy information owned by a server having content (content server) to another location on the network near a reference requesting person (client), thereby making the client refer the copy to reduce the traffic of the content flowing over the network.

Among the above-mentioned technologies, (1) the cache technology is especially effective in a case where the content is not changed. However, cases have been recently increasing which can not be supported only by caching of the content such as a web server dynamically generating the content upon client's access.

In order to solve this, a technology of minutely separating the content, even if the content is dynamically generated as a whole, into dynamic portions and statistic portions, and increasing the ratio of the content which can be cached by cashing the portions other than the dynamic portions has been developed.

Also, as another approach, there is a technology of caching dynamic content, and increasing a hit rate of the cache by automatically updating the cache when the content is changed.

On the other hand, (2) the mirroring technology is suitable for a case where a large amount of data is copied at a fixed period.

Also, as other prior art technologies, there are a network server detecting a frequency with which cache data is accessed by a client terminal, notifying that the frequency has exceeded a prescribed frequency to a control circuit, and requesting a main server to read update data of the cache data based on a notification signal, and a data update method using the network server (see e.g. patent document 1).

Furthermore, there are a system and method for reducing a time to deliver information from a communication network to a user. In order to keep all data the user needs as close to the user as possible, user's characteristics and usage patterns are used to determine what to cache and for how long, what to pre-fetch, what to refresh, and what to retrieve. In addition, by segmenting information and utilizing parallel communication channels, a data transfer across the last mile can be significantly increased (see e.g. patent document 2).

[Patent Document 11 Japanese Patent Application Laid-open No. 2001-175527

[Patent Document 2] Japanese Translation of PCT International Application No. 2004-535631.

Although an update frequency of content is extremely high in the above-mentioned cache technology, the cache has not been effective in such a case where a reference request frequency by a client is low.

Also, in the mirroring technology, a requesting source's intention is not reflected during the period, so that there has been a problem that the reduction of the traffic can not be expected if the period is matched to the conceivably shortest period.

### SUMMARY OF THE INVENTION

It is accordingly an object of the present invention to provide a content retrieval system by which traffic flowing can be reduced by effectively utilizing a cache even when an update frequency of content is extremely high while a reference request frequency by a client is low.
[1] In order to achieve the above-mentioned object, a content retrieval system according to the present invention comprises a client generating a content reference request including unique information and an attribute of a desired content; and a cache server checking, based on the content reference request from the client, a presence/absence of a cache of the content, transmitting to a content server a content synchronization request including the unique information and the attribute in the absence of the cache of the content, caching the content when the content is transmitted from the content server having received the content synchronization request, and performing synchronization mirroring with the content server based on the attribute after the cache server has transmitted the content to the client.
[2] In the presence of the cache of the content, the above-mentioned cache server may perform the synchronization mirroring with the content server based on the attribute after the cache server has transmitted the content held to the client.
[3] Also, for the above-mentioned synchronization mirroring, the cache server may take an initiative to detect a cache update based on the attribute and may request the cache update from the content server.
[4] Furthermore, for the above-mentioned synchronization mirroring, the content server may take an initiative to detect a cache update based on the attribute and may request the cache update by transmitting a cache notification including the content to the cache server.
[5] Also, a content retrieval system according to the present invention may comprise a client generating a content reference request including unique information and an attribute of a desired content; and a cache server checking, based on the content reference request from the client, a presence/absence of a cache of the content, transmitting to a content server a content synchronization request including the unique information and the attribute in the absence the cache of the content, and transmitting to the client a content reference response that the content is temporarily unavailable when the cache server receives a content synchronization response that the content is temporarily unavailable from the content server having received the content synchronization request.
[6] Also, a content retrieval system according to the present invention may comprise a client generating a content reference request including unique information and an attribute of a desired content; and a cache server checking, based on the content reference request from the client, a presence/absence of a cache of the content, checking information of a content server held by the cache server itself in the absence of the cache of the content, and transmitting to the client, when the content server has found that the content is temporarily unavailable, a content reference response indicating that the content is temporarily unavailable.
[7] Furthermore, when the content becomes available, the above-mentioned content server may request a cache update by transmitting a cache notification including the content to the cache server.

The cache server may update information on the content server every time the above-mentioned cache server receives the information from the content server, and the content server may update information on the cache server every time the content server receives the information from the cache server.

It is to be noted that the above-mentioned attribute may comprise e.g. a lifetime of a cache and a reference desired interval thereof.

The content retrieval system according to the present invention can be configured by a network, schematically shown in FIG. 1, comprising clients 1 referring to content, a cache server 2, a content server 3 and applications 4 registering the content.

Hereinafter, the above-mentioned [1]-[7] will be described referring to FIGS. 2-8. It is to be noted that while matters not described in the claims are indicated, those matters are only examples.

[1] Content Referring Operation in the Absence of cash in Cache Server (Initial State) FIG. 2

1. The client 1 transmits a content reference request including unique information and an attribute of content to the cache server triggered by e.g. a request from an application (at step S1). The attribute includes e.g. a lifetime and a reference desired interval thereof.
2. The cache server 2 checks the presence of a cache (at step S2), and content server information (at step S3 e.g. whether or not synchronization mirroring was previously performed). Since no cache exists at this point, the cache server 2 transmits a content synchronization request including the unique information and the attribute to the content server 3 (at step S4). In this case, even if the synchronization mirroring has never been performed so far, a destination content server can be determined by various methods. Concurrently, the cache server 2 holds or caches the attribute of the content synchronization request transmitted and information of the content server as the transmitting destination.
3. The content server 3 holds the unique information and the attribute of the content requested from the client 1 in common with the cache server 2, and transmits the requested content to the cache server 2 (at step S6).

It is to be noted that the content server 3 receives a content registration request independently of the above-mentioned operation from the content registration application 4 to register the content (at step T1 T11 and T12). This is applied to each operation example.
4. The cache server 2 caches the received content (at step S7), updates the content server information (at step S8), and transfers the requested content to the client 1 (at step S9).
5. Hereafter, according to the above-mentioned attribute held, the synchronization mirroring is performed at a fixed period between the cache server 2 and the content server 3 (at step S10), so that the cache is updated. The synchronization mirroring will be described later in association with FIGS.4 and 5.
   [2] Content Referring Operation in the Presence of Cache in Cache Server FIG. 3
1. It is supposed that the synchronization mirroring has been performed at a fixed period between the cache server 2 and the content server 3 (at step S10_1).
2. In the same way as the above-mentioned [1]1., the client 1 transmits the content reference request including the attribute to the cache server 2 triggered by the request from the application (at step S1).
3. The cache server 2 checks the cache (at step S2), checks the content server information (at step S3), and transmits the cache held by the above-mentioned synchronization mirroring (at step S10_1) to the client 1 (at step S9).
4. Hereafter, in the same way as the above-mentioned [1]5., the synchronization mirroring is performed (at step S10_2).
   [3] Cache Update Operation in Case where a Cache Server takes an Initiative FIG. 4 (Synchronization Mirroring of FIGS.2 and 3)
1. The cache server 2, based on the unique information and the attribute of the content obtained from the content reference request, autonomously detects that the cache update is necessary from the information held and managed by the cache server 2 itself (at step S11).
2. The cache server 2 generates the content synchronization request including the unique information and the attribute to be transmitted to the content server 3 (at step S12).
3. The content server 3 receives the content synchronization request, and transmits the content already registered at step T1 (at step S14). At this time, if necessary, the content server 3 updates the information of the cache server 2 managed by the content server 3 itself (at step S13).
4. The cache server 2 updates the cache by the received content (at step S15). Also, the cache server 2 updates the information of the content server 3 managed by the cache server 2 itself (at step S16).

As a case where the cache update is effective in which the cache server takes an initiative, it can be mentioned satisfying the following condition
Where the number of cache servers is large, and respective content synchronization requests are different from each other.

In this case, it is supposed that the content server performs no processing other than returning a response to the respective content synchronization request, thereby enabling a load of the content server to be reduced.
[4] Cash Update operation in Case where a Content Server takes an Initiative FIG. 5 (Synchronization Mirroring of FIGS. 2 and 3)
1. The content server 3 autonomously detects from the information (unique information and attribute of content) held and managed by the content server 3 itself (at step S21) that the cache update is necessary. It is to be noted that after this detection the cache server information is checked, which is omitted for simplifying the figure.
2. The content server 3 generates a cash notification including content to be transmitted to the cash server 2 (at step S22).
3. The cache server 2 updates the cache by the content received (at step S23). If necessary, the information of the content server held and managed by the cache server 2 itself is updated (at step S24) and a response (ACK) is returned (at step S25).
4. The content server 3 updates the information of the cache server 2 held and managed by the content server 3 itself after the reception of the response (at step S26).

As a case where the cache update is effective in which the content server takes an initiative, it can be mentioned satisfying the following conditions
Where the number of cache servers is large, and respective synchronization request requirements are the same or similar; and
Where the cache notification can be delivered by a method of multicast or a similar method.

In these cases, the content server manages the transmitting destination and performs the cache notification. However, by using the multicast or the like, the number of cache notifications transmitted is reduced, thereby enabling the load of the content server to be reduced.

[5] Content Referring Operation when Content is Temporarily Unavailable in the Absence of Cache in Cache Server FIG. 6

1. The client 1 transmits the content reference request including the unique information and the attribute of the content to the cache server 2 triggered by the request from the application (at step S1).
2. The cache server 2 checks the cache (at step S2), and checks the content server information (at step S3). As a result, it is found that there is no cache, so that the cache server 2 transmits the content synchronization request including the above-mentioned unique information and attribute to the content server 3 (at step S4). Concurrently, the cache server 2 holds the attribute of the content synchronization request transmitted and the content server information of the transmitting destination.
3. The content server 3 obtains the unique information and the attribute of the content requested from the client 1 from the content synchronization request to be held in common with the cache server 2. When it is found that the requested content is temporarily unavailable, the information is transmitted to the cache server 2 as a content synchronization response (at step S31).
4. The cache server 2 caches the content synchronization response of “temporarily unavailable” received (at step S32), updates the content server information (at step S33), and transmits the information (information “temporarily unavailable”) to the client 1 as the content reference response (at step S34).
5. The client 1 transfers the received information to the application.
   [6] Content Referring Operation Example in the Presence of Cache Indicating Content being Temporarily Unavailable in Cache Server FIG. 7
1. The client 1 transmits the content reference request including the attribute to the cache server 2 triggered by the request from the application (at step S1).
2. The cache server 2 checks the cache (at step S2), and checks the content server information (at step S3). As a result, when it is found that there is no cache and further the content requested by the client 1 is temporarily unavailable from the content server information, the cache server 2 returns the information to the client 1 as the content reference response (at step S34).
3. The client 1 transfers the information received to the application.
   [7] Cache Update Operation in Case where Content having been Temporarily Unavailable in Cache Server becomes Available FIG. 8
1. The content server 3 autonomously detects a status update of the content (content having been temporarily unavailable becomes available) (at step S41), transmits the cache notification including the content to the cache server 2, and requests the cache update (at step S42). Also in this case, the check of the cache server information is omitted in the figure.
2. The cache server 2 updates the cache (at step S43) and updates the content server information (at step S44).
3. The cache server 2 returns a response (ACK) to the content server 3 (at step S45). The content server 3 receives the response, and then updates the cache server information (at step S46).

As described above, according to the present invention, the client explicitly transmits the requirements concerning the cache to the cache server, thereby enabling the cache over the cache server to satisfy the request of the client. Therefore, even if the update frequency of the content is extremely high while a reference request frequency of the client is low, cache operations exceeding the requirement of the client are not performed, thereby enabling the cache to be effectively used and the traffic to be reduced.

Also, when the client retrieves the content, the client concurrently retrieves the location where the content exists (address of the server), and centralizes the information to be cached, thereby eliminating a redundant retrieval of the content.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which

FIG. 1 is a block diagram showing a network arrangement to which a content retrieval system according to the present invention is applied;

FIG. 2 is a sequence diagram showing a principle [1] of a content retrieval system according to the present invention;

FIG. 3 is a sequence diagram showing a principle [2] of a content retrieval system according to the present invention;

FIG. 4 is a sequence diagram showing a principle [3] of a content retrieval system according to the present invention;

FIG. 5 is a sequence diagram showing a principle [4] of a content retrieval system according to the present invention;

FIG. 6 is a sequence diagram showing a principle [5] of a content retrieval system according to the present invention;

FIG. 7 is a sequence diagram showing a principle [6] of a content retrieval system according to the present invention;

FIG. 8 is a sequence diagram showing a principle [7] of a content retrieval system according to the present invention;

FIG. 9 is a block diagram showing an embodiment of a cache server used for a content retrieval system according to the present invention;

FIG. 10 is a block diagram showing an embodiment of a content server used for a content retrieval system according to the present invention;

FIG. 11 is a block diagram showing an embodiment of a client used for a content retrieval system according to the present invention;

FIG. 12 is a sequence diagram showing an operation example (1) of a cache server used for a content retrieval system according to the present invention;

FIG. 13 is a diagram showing an embodiment of a content reference request used for a content retrieval system according to the present invention;

FIG. 14 is a diagram showing an embodiment of a content synchronization request used for a content retrieval system according to the present invention;

FIG. 15 is a sequence diagram showing an operation example (2) of a cache server used for a content retrieval system according to the present invention;

FIG. 16 is a diagram showing an embodiment of a content synchronization response (normal response) used for a content retrieval system according to the present invention;

FIG. 17 is a diagram showing an embodiment of a content reference response (normal response) used for a content retrieval system according to the present invention;

FIG. 18 is a sequence diagram showing an operation example (3) of a cache server used for a content retrieval system according to the present invention;

FIG. 19 is a sequence diagram showing an operation example (4) of a cache server used for a content retrieval system according to the present invention;

FIG. 20 is a sequence diagram showing an operation example (5) of a cache server used for a content retrieval system according to the present invention;

FIG. 21 is a sequence diagram showing an operation example (6) of a cache server used for a content retrieval system according to the present invention;

FIG. 22 is a diagram showing an embodiment of a cache notification used for a content retrieval system according to the present invention;

FIG. 23 is a diagram showing an embodiment of a cache notification response used for a content retrieval system according to the present invention;

FIG. 24 is a sequence diagram showing an operation example (7) of a cache server used for a content retrieval system according to the present invention;

FIG. 25 is a diagram showing an embodiment of a content synchronization response (response of temporarily unavailable/unavailable) used for a content retrieval system according to the present invention;

FIG. 26 is a diagram showing an embodiment of a content reference response (response of temporarily unavailable/unavailable) used for a content retrieval system according to the present invention;

FIG. 27 is a sequence diagram showing an operation example (8) of a cache server used for a content retrieval system according to the present invention;

FIG. 28 is a sequence diagram showing an operation example (1) of a content server used for a content retrieval system according to the present invention;

FIG. 29 is a sequence diagram showing an operation example (2) of a content server used for a content retrieval system according to the present invention;

FIG. 30 is a sequence diagram showing an operation example (3) of a content server used for a content retrieval system according to the present invention;

FIG. 31 is a sequence diagram showing an operation example (4) of a content server used for a content retrieval system according to the present invention;

FIG. 32 is a sequence diagram showing an operation example (1) of a client used for a content retrieval system according to the present invention; and

FIG. 33 is a sequence diagram showing an operation example (2) of a client used for a content retrieval system according to the present invention.

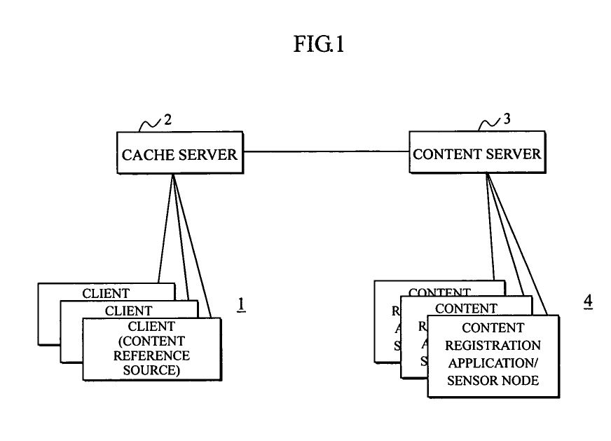

### DESCRIPTION OF THE EMBODIMENTS

Each embodiment of the cache server 2, the content server 3, and the client 1 composing the content retrieval system according to the present invention will now be described.

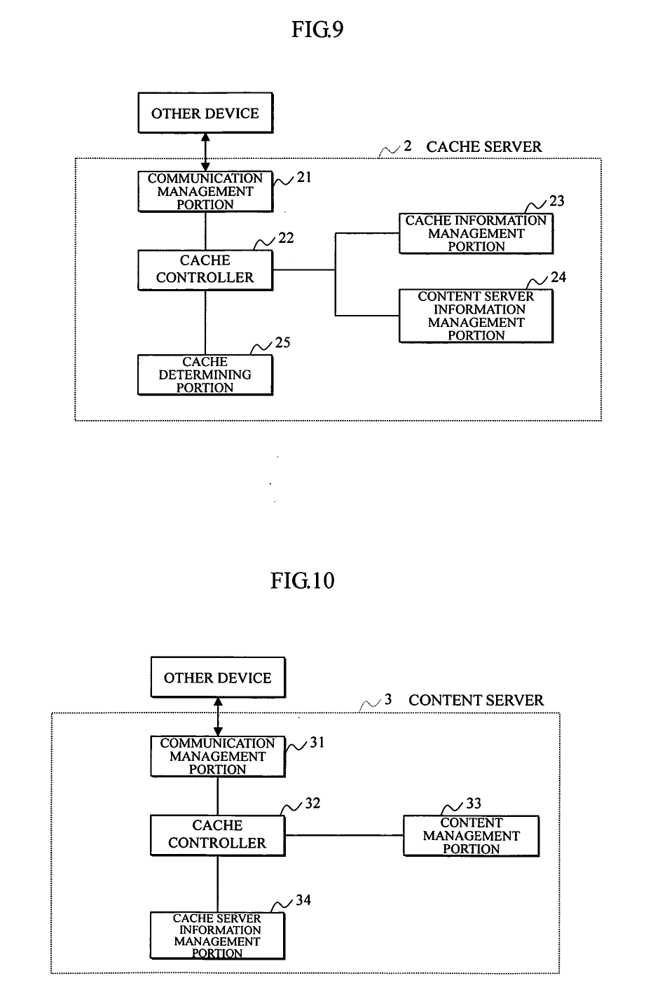

### Embodiment of Cache Server FIG. 9

Communication Management Portion 21

This portion 21 receives a message addressed to the cache server 2, and distributes requests to each function required according to processing. If the message is associated with a cache, the communication management portion has a function of transferring the message to a cache controller 22. Also, receiving requests from each portion, the communication management portion 21 transmits the messages.

Cash Controller 22

This controller 22 has a function of determining processing required for each case triggered by the request from each portion, and distributing the processing to each portion.

Cash Information Management Portion 23

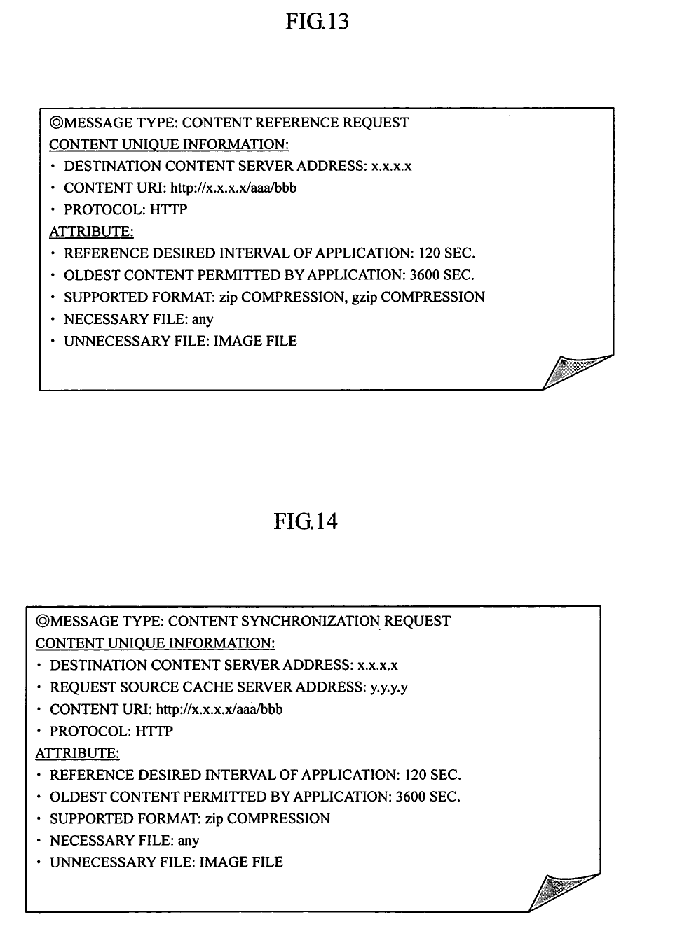

This portion 23 has a function of holding/managing content (URI) to be cached and an attribute (lifetime of cache, reference desired interval thereof, and the like see FIG. 13) requiring the content.

Content Server Information Management Portion 24

This portion 24 has a function of holding/managing content to be cached and information of a content server holding the original.

Cash Determining Portion 25

This portion 25 has a function of determining the content to be cached and the attribute thereof based on the request from the client 1. For example, the portion 25 has a function of determining an optimum compression method concerning a plurality of clients.

### Embodiment of Content Server FIG. 10

Communication Management Portion 31

This portion 31 receives a message addressed to the content server 3, and has the same function as the above-mentioned communication management portion 21.

Cache Controller 32

This controller 32 has the same function as the above-mentioned cache controller 22.

Content Management Portion 33

This portion 33 has a function of holding/managing the content registered/updated from the content registration application 4. It is to be noted that the content registration application 4 may be installed on the content server 3 itself, where the content is internally registered/updated.

Cash Server Information Management Portion 34

This portion 34 has a function of holding/managing the information of the cache server caching the content and the above-mentioned attribute.

### Embodiment of Client FIG. 11

Communication Management Portion 11

This portion 11 receives a message addressed to the client 1, and distributes requests to each portion required according to the processing. If the message is a response message of the cache request, the portion 11 has a function of transferring the message to a cache request controller 12. Also, the communication management portion 11 transmits the message when receiving a request from each portion.

Cache Request Controller 12

This controller 12 has a function of determining processing required for each case triggered by a request from each portion, and distributing processing to each function.

Application Management Portion 13

Since the cache server 2 determines the content to be cached and the attribute thereof, the application management portion 13 has a function of managing the attribute required for each application.

Hereinafter, operation embodiments of the cache server 2, the content server 3, and the client 1 will be described in this order.

### Operation Example of Cache Server

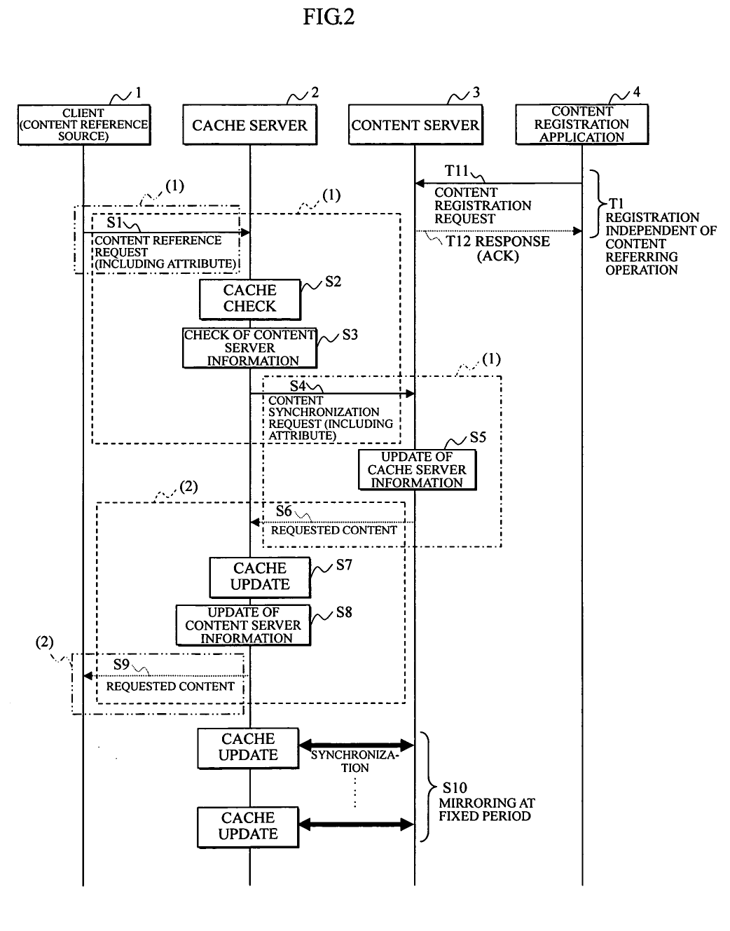

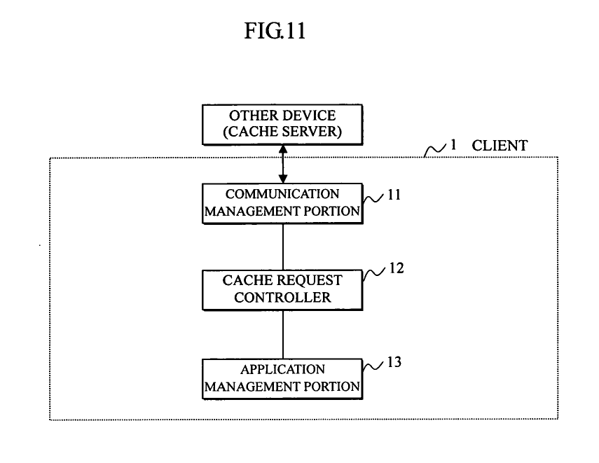

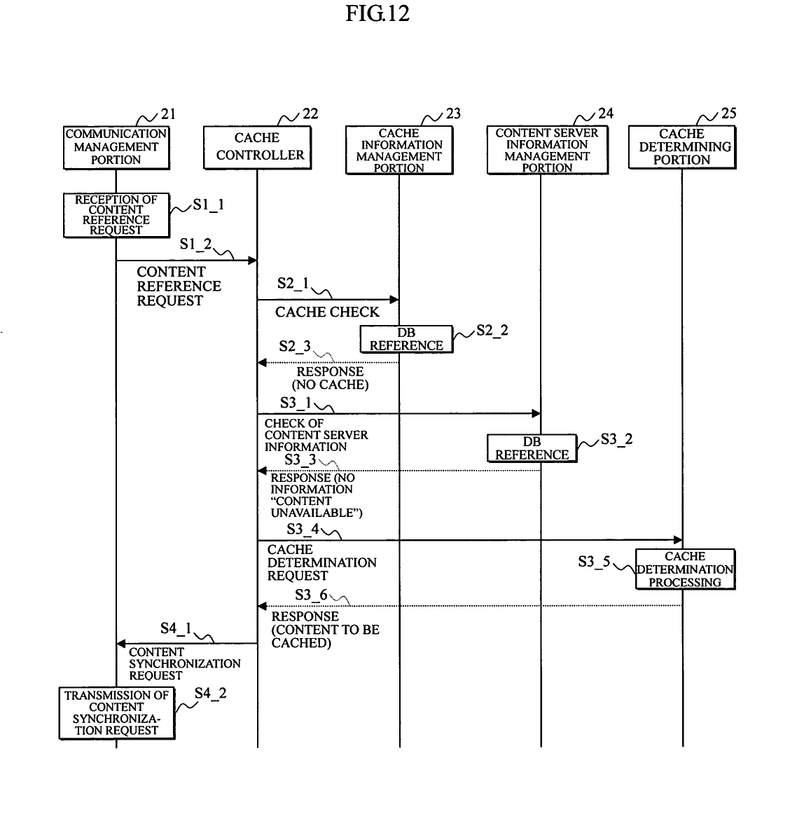

(1) Operation Example of Cache Server when having Received A cache Reference Request (In the Absence of Cache in Cache Server) FIGS. 12 and 2 (Dotted Line Portion (1))

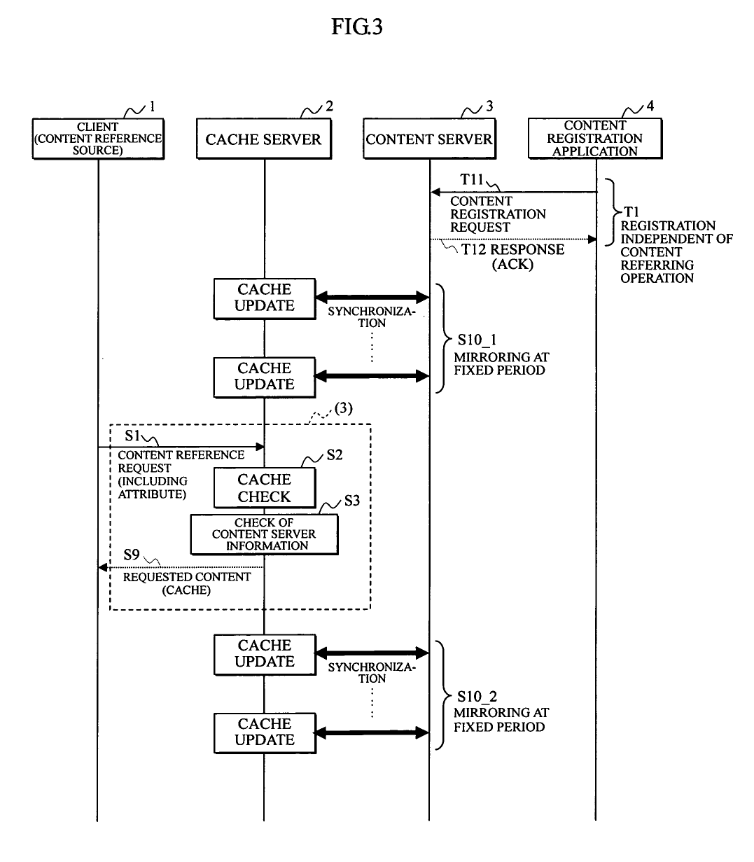

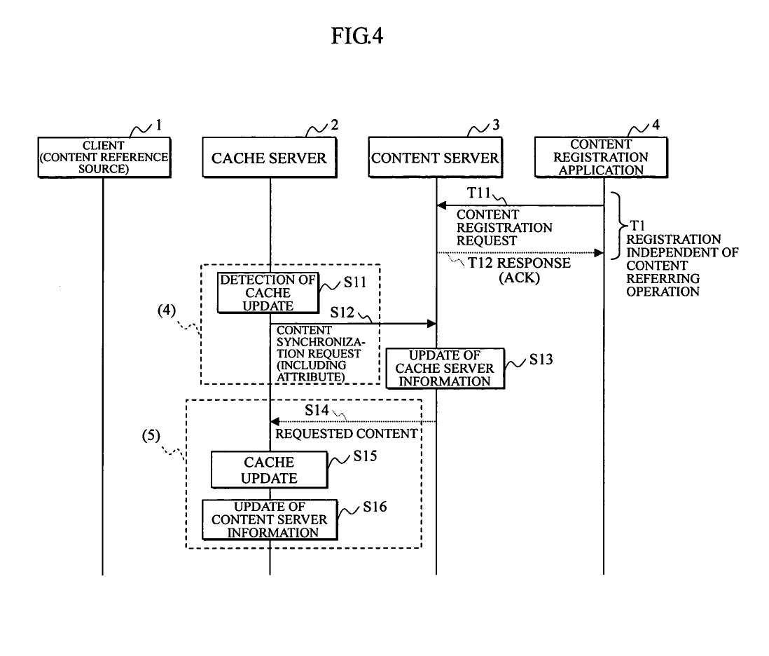

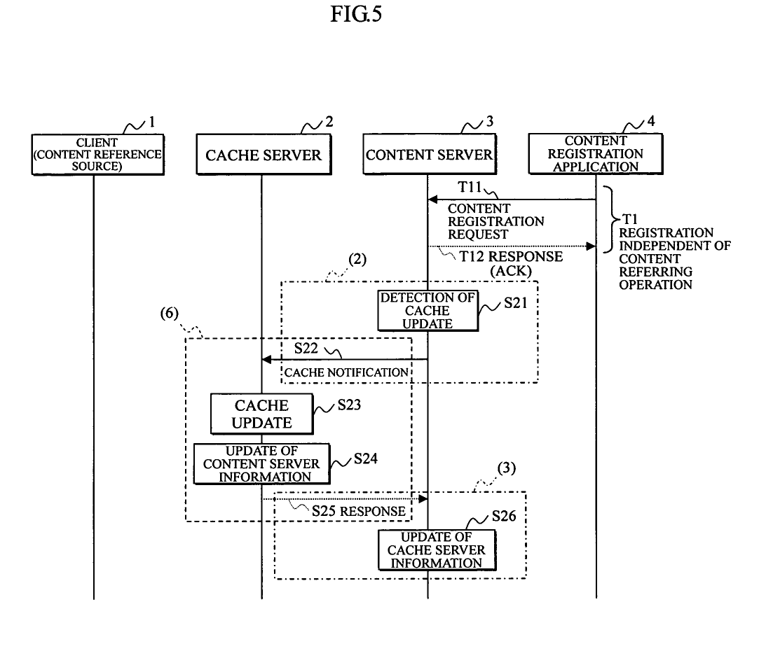

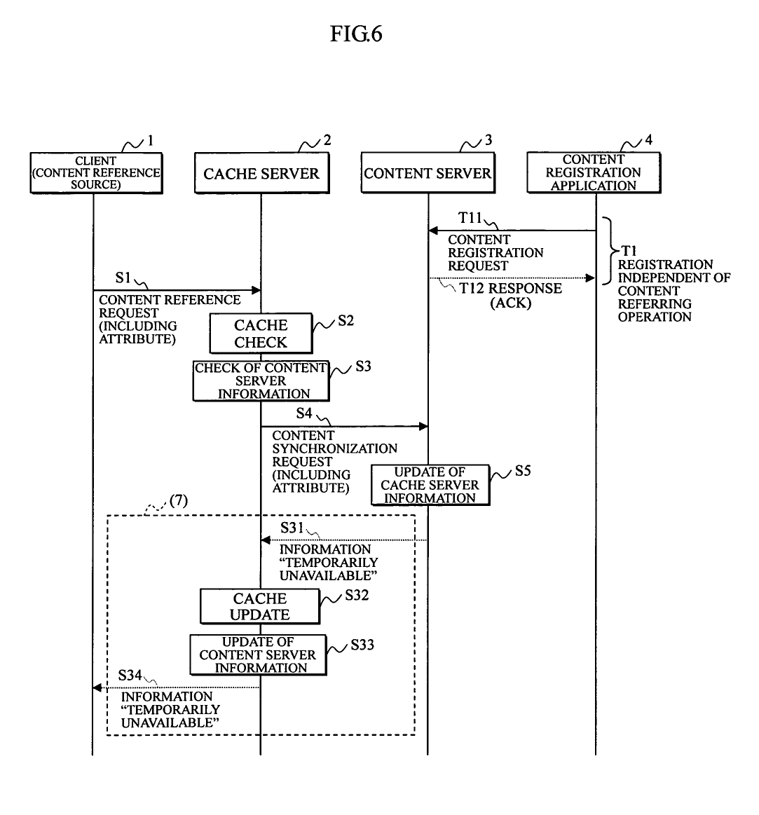

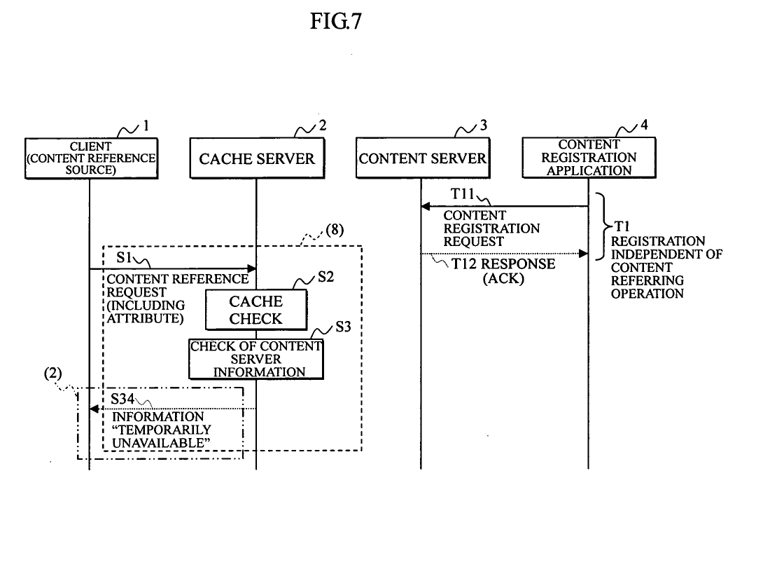

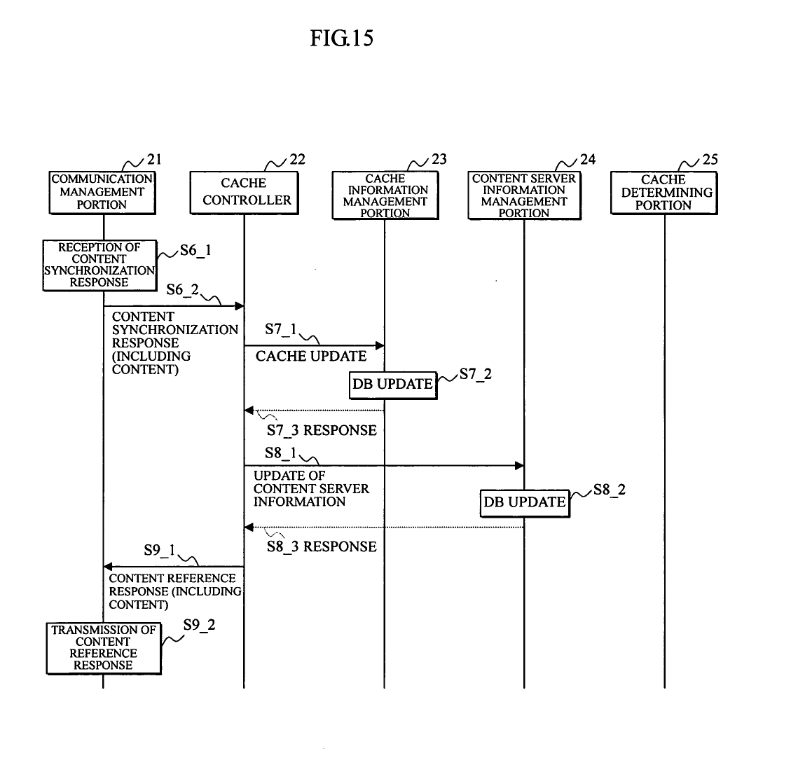

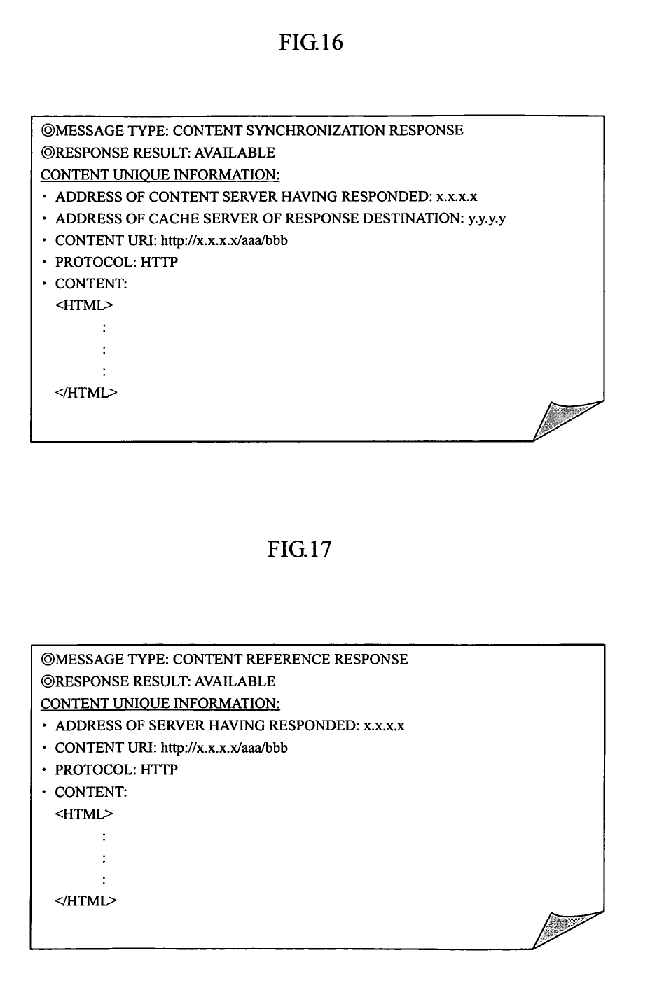

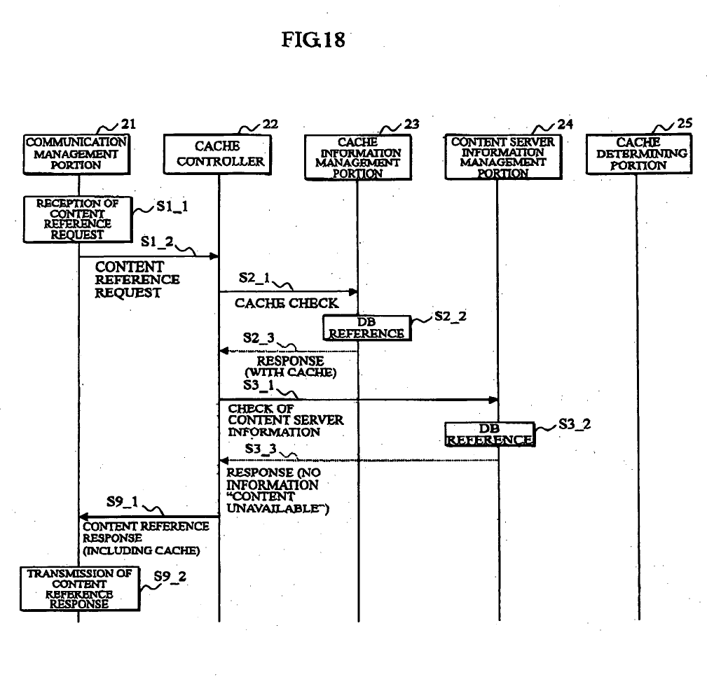

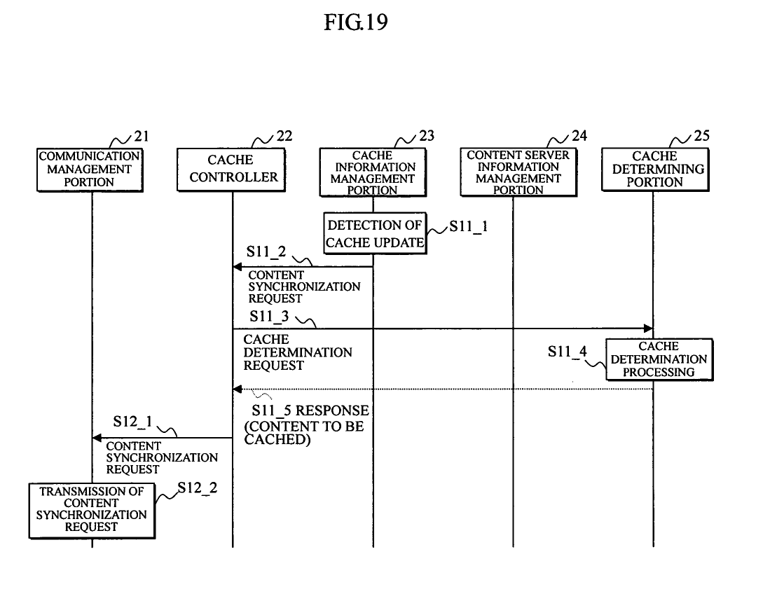

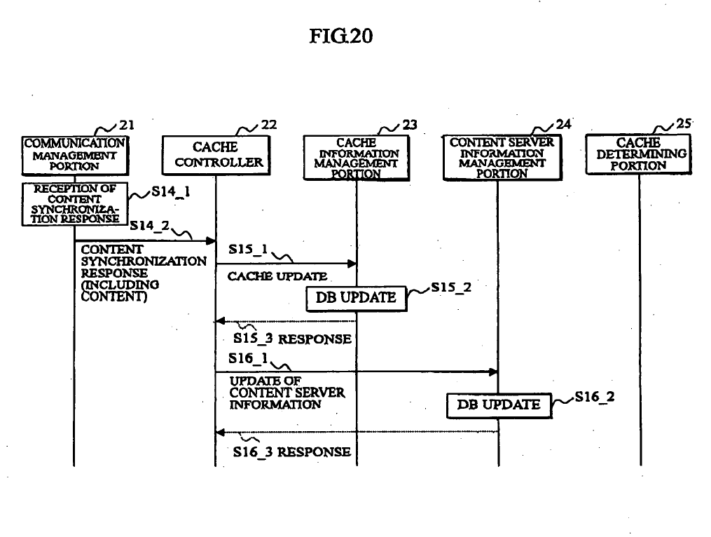

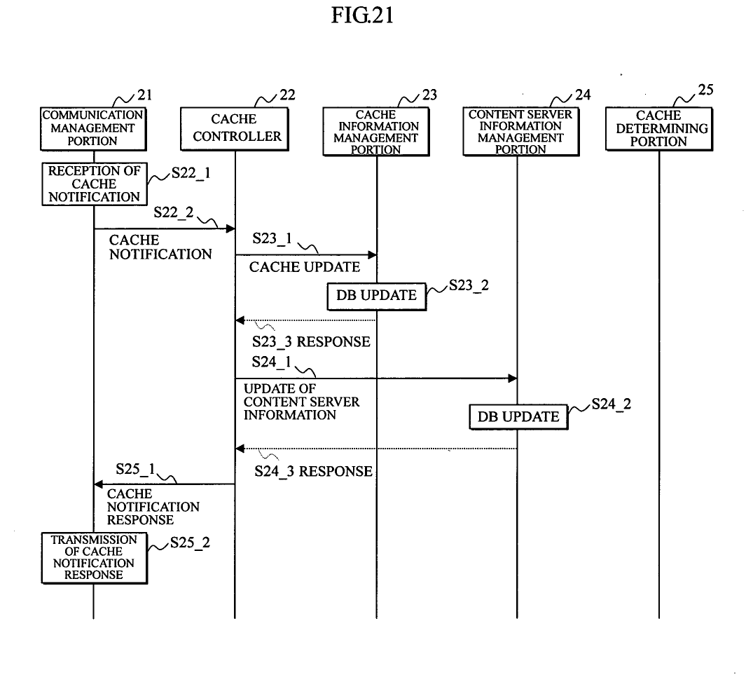

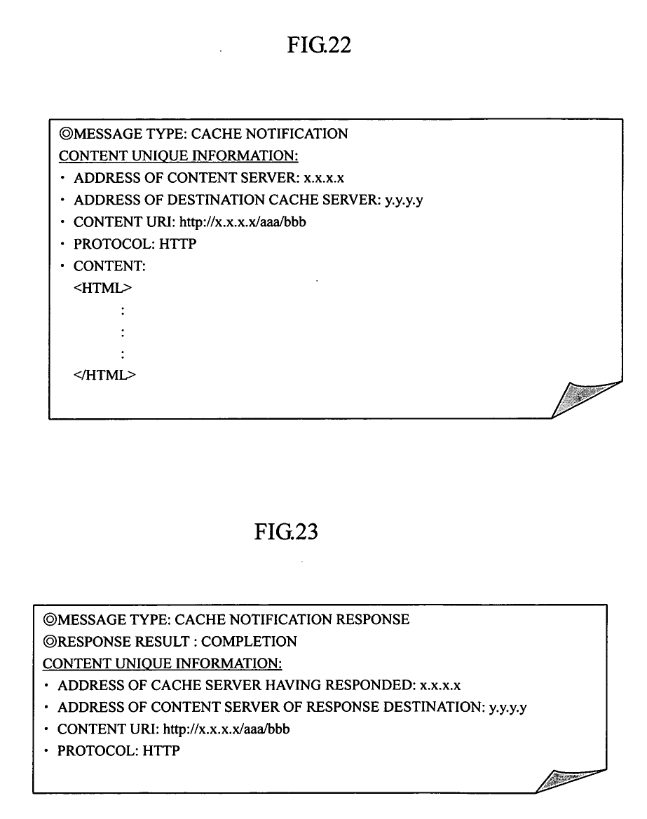

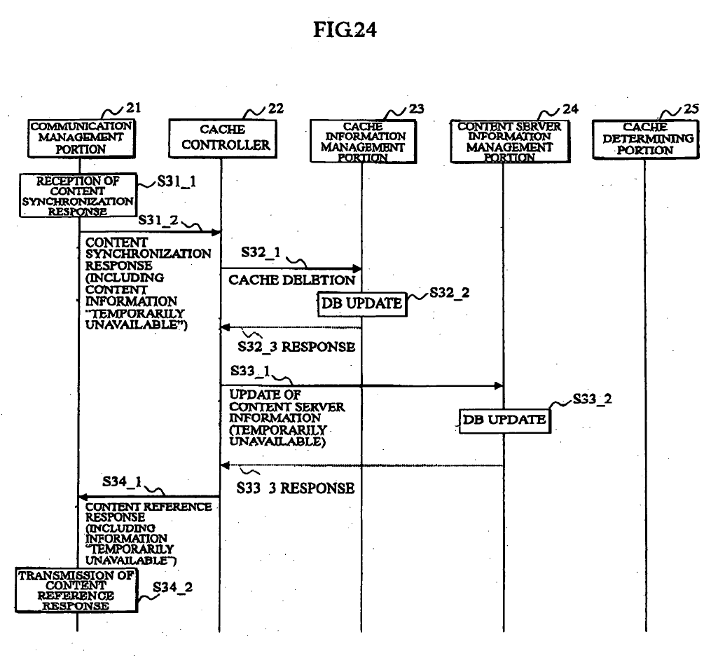

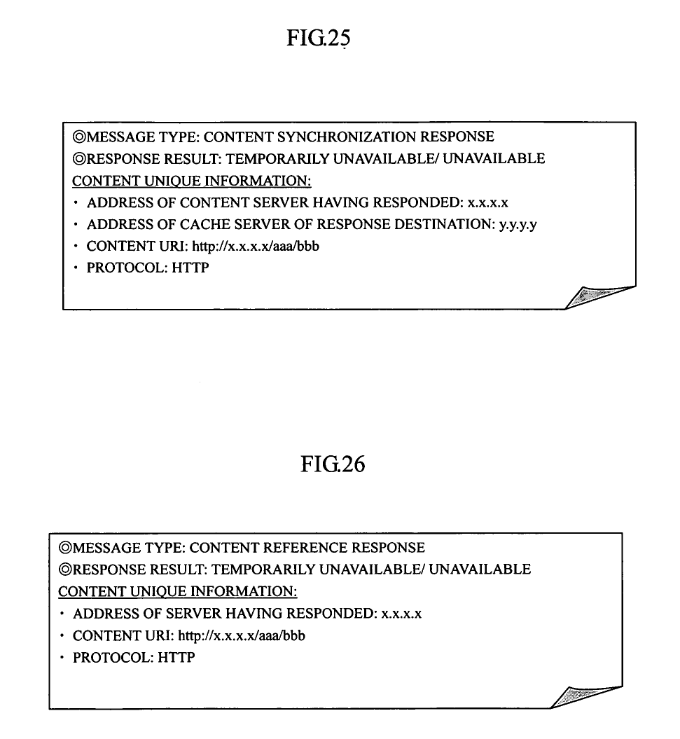

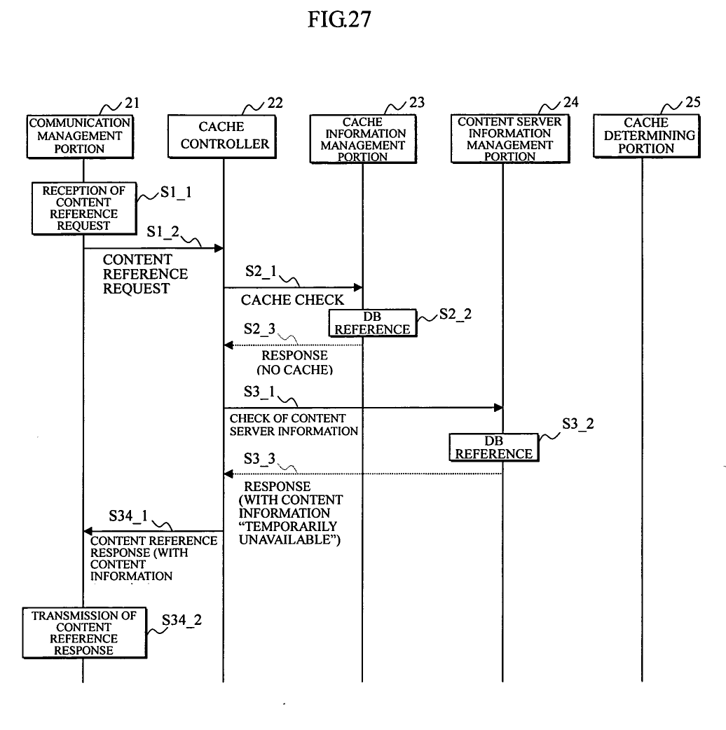

1. When receiving the content reference request (see FIG. 13) from the client 1 (step S1_1), the communication management portion 21 transfers the content reference request to the cache controller 22 (at step S1_2).
2. The cache controller 22 inquires of the cache information management portion 23 about checking the cache (at step S2_1) by referring to the database (DB) (at step S2_2). As a result, in this example, the cache controller 22 receives a response (at step S2_3) indicating that there is no cache, from the cache information management portion 23.
3. The cache controller 22 inquires of the content server information management portion 24 about checking the content server information (at step S3_1) by referring to the database (at step S3_2). As a result, the cache controller 22 receives a response indicating that there is no information of “content unavailable” (at step S3_3).
4. The cache controller 22 transfers the cache determination request (at step S3_4) to the cache determining portion 25, which determines contents to be cached (at step S3_5). As a response thereto (at step S3_6), the cache controller 22 receives the contents to be cached.
5. Upon receiving the contents to be cached, the cache controller 22 generates the content synchronization request (at step S4_1 see FIG. 14) to be transferred to the communication management portion 21. It is to be noted that since the contents to be cached in this case have been determined by e.g. the optimum compression method, “zip compression” is selectively determined in FIG. 14.
6. The communication management portion 21 transmits the content synchronization request (at step S4_1) to a predetermined content server 3 (at step S4_2).
   (2) Operation Example of Cache Server when having Received a Content Synchronization Response (In the Absence of Cache in Cache Server) FIGS. 15 and 2 (Dotted Line Portion (2))
1. When receiving the content synchronization response (see FIG. 16) including the content from the content server 3 (at step S6_1), the communication management portion 21 transfers the response to the cache controller 22 (at step S6_2).
2. The cache controller 22 instructs the cache information management portion 23 to update the cache (at step S7_1), and the cache information management portion 23 updates the corresponding database (at step S7_2) and then returns the response (at step S7_3).
3. The cache controller 22 instructs the content server information management portion 24 to update the content server information (at step S8_1). The content server information management portion 24 updates the corresponding database (at step S8_2), and then returns the response including the content (at step S8_3).
4. The cache controller 22 generates a content reference response by using the received content (at step S9_1 see FIG. 17) to be transferred to the communication management portion 21.
5. The communication management portion 21 transmits the content reference response to the requested source (at step S9_2).
   (3) Operation Example of Cache Server when having Received A Content Reference Request (In the Presence of Cache in Cache Server) FIGS.18 and 3 (Dotted Line Portion (3))
1. When receiving the content reference request (see FIG. 13) (at step S1_1), the communication management portion 21 transfers the request to the cache controller 22 (at step S1_2).
2. The cache controller 22 inquires of the cache information management portion 23 about checking the cache (at step S2_1) and referring the database (at step S2_2). As the response thereof, the cache controller 22 receives the cache (at step S2_3).
3. The cache controller 22 inquires of the content server information management portion 24 about checking the content server information (at steps S3_1 and S3_2). As a result, the cache controller 22 receives the response indicating that there is no information of “content unavailable” (at step S3_3).
4. The cache controller 22 generates the content reference response (at step S9_1 see FIG. 17) by using the received cache and transfers the response to the communication management portion 21.
5. The communication management portion 21 transmits the content reference response to the requested source (at step S9_2).
   (4) Operation Example when A Cache Server Detects the Cache Update Time (Cache Update In Which A Cache Server Takes An Initiative): FIGS. 19 and 4 (Dotted Line Portion (4))
1. The cache information management portion 23 autonomously detects that the timing of the cache update has come based on e.g. the lifetime and the reference desired interval among the above-mentioned attributes (at step S11_1), and transfers the content synchronization request to the cache controller 22 (at step S11_2).
2. The cache controller 22 transfers the cache determination request to the cache determining portion 25 (at step S11_3), which determines the contents to be cached (at step S11_4).
3. The cache controller 22 receives the contents to be cached (at step S11_5), and generates the content synchronization request (at step S12_1 see FIG. 14) to be transferred to the communication management portion 21.
4. The communication management portion 21 transmits the content synchronization request to the content server 3 (at step S12_2).
   (5) Operation Example of Cache Server when having Received A Content Synchronization Response (Cache Update in which A Cache Server Takes an Initiative) FIGS. 20 and 4 (Dotted Line Portion (5))
1. When receiving the content synchronization response (see FIG. 16) from the content server 3 (at step S14_1), the communication management portion 21 transfers the response including the content to the cache controller 22 (at step S14_2).
2. The cache controller 22 instructs the cache information management portion 23 to update the cache (at steps S15_1 and S15_2), and the cache information management portion 23 returns the response (at step S15_3).
3. The cache controller 22 instructs the content server information management portion 24 to update the content server information (at steps S16_1-S16_3).
(6) Operation Example Of Cache Server When Having Received A Cache Notification (Cache Update In Which A Content Server Takes An Initiative) FIGS.21 And 5 (Dotted Line Portion (6))
1. When receiving a cache notification (see FIG. 22) (at step S22_1), the communication management portion 21 transfers the notification to the cache controller 22 (at step S22_2). 2. The cache controller 22 instructs the cache information management portion 23 to update the cache (at steps S23_1-S23_3).
3. The cache controller 22 instructs the content server information management portion 24 to update the content server information (at steps S24_1-S24_3).
4. The cache controller 22 generates the cache notification response (at step S25_1 see FIG. 23) to be transferred to the communication management portion 21.
5. The communication management portion 21 transmits the cache notification response to the requested source (at step S25_2).
(7) Operation Example of Cache Server when having Received A Content Synchronization Response (When Content is Temporarily Unavailable in the Absence of Cache in Cache Server) FIGS. 24 and 6 (Dotted Line Portion (7))
1. When receiving the content synchronization response (see FIG. 25) including information of “content is temporarily unavailable” (at step S31_1), the communication management portion 21 transfers the response to the cache controller 22 (at step S31_2).
2. The cache controller 22 requests the cache information management portion 23 to delete the cache temporarily unavailable (at steps S32_1-S32_3).
3. The cache controller 22 instructs the content server information management portion 24 to update the content server information “temporarily unavailable” (at steps S33_1-S33_3).
4. The cache controller 22 generates the content reference response (see FIG. 26) including the information of “content is temporarily unavailable” to be transferred to the communication management portion 21 (at step S34_1).
5. The communication management portion 21 transmits the content reference response to the requested source (at step S34_2).
   (8) Operation Example of Cache Server when having Received A Content Reference Request (When Content is Temporarily Unavailable in the Presence of Cache in Cache Server) FIGS.27 And 7 (Dotted Line Portion
1. When receiving the content reference request (see FIG. 13) (at step S1_1), the communication management portion 21 transfers the request to the cache controller 22 (at step S1_2).
2. The cache controller 22 inquires of the cache information management portion 23 about checking the cache (at steps S2_1 and S2_2). As a result, a response indicating that there is no cache (at step S2_3) is received.
3. The cache controller 22 inquires of the content server information management portion 24 about checking the content server information (at steps S3_1 and S3_2). As the response thereof, the cache controller 22 receives the content unavailable information (at step S3_3).
4. The cache controller 22 generates the content reference response (at step S34_1 see FIG. 26) including the information of “content is unavailable” to be transferred to the communication management portion 21.
5. The communication management portion 21 transmits the content reference response to the requested source (at step S34_2).

### Operation Example of Content Server

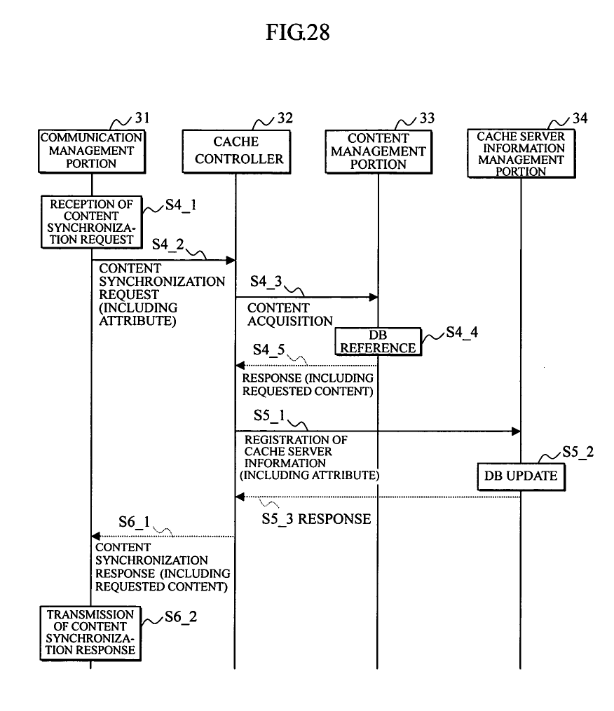

(1) Operation Example of Content Server when having Received A Content Synchronization Request FIGS. 28 and 2 (One-Dot Chain Line Portion (1))

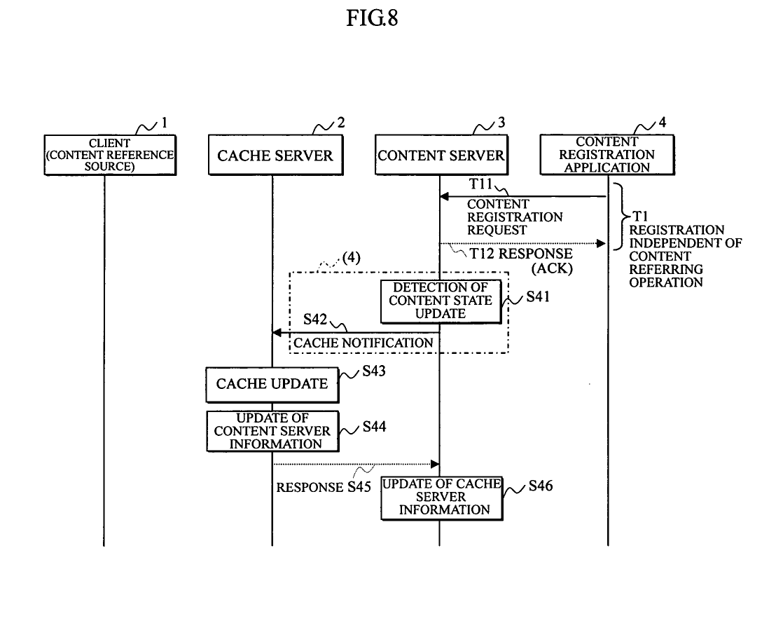

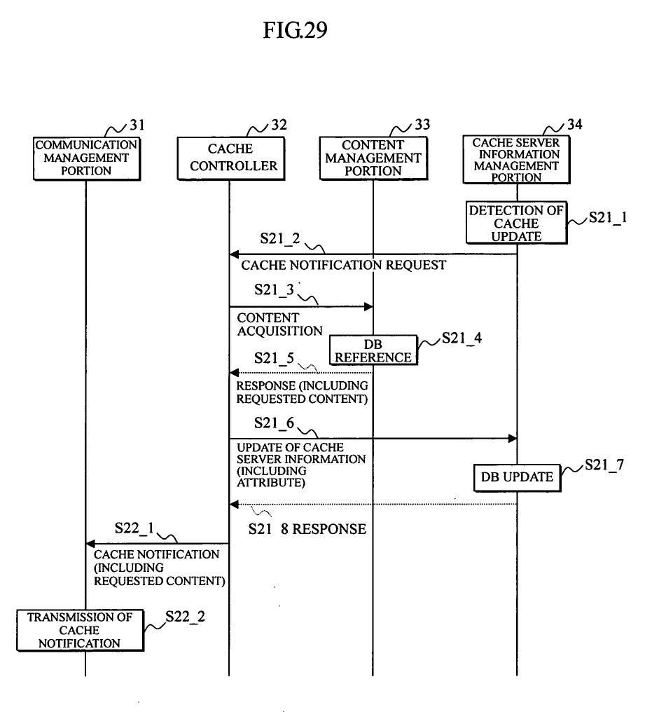

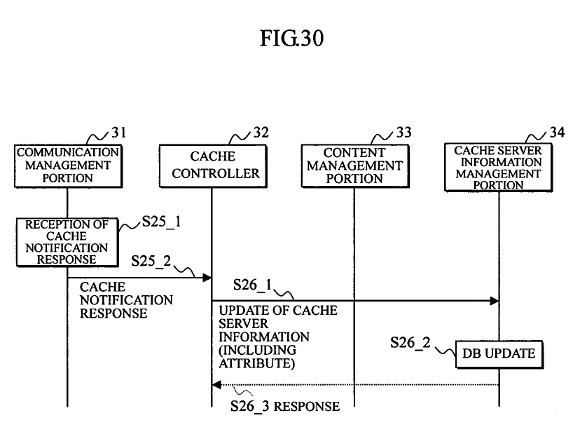

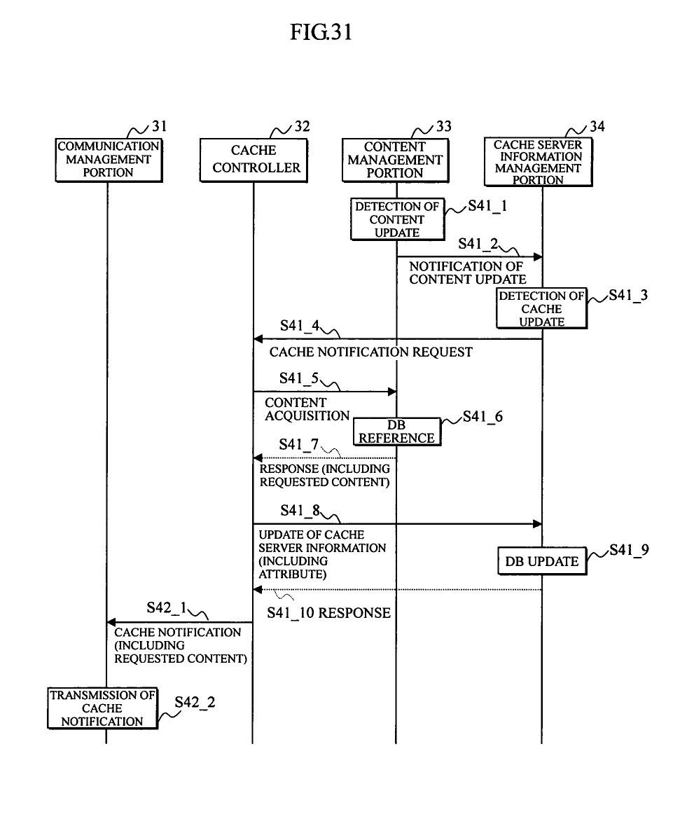

1. When receiving the content synchronization request (see FIG. 14) (at step S4_1), the communication management portion 31 transfers the request to the cache controller 32 (at step S4_2).
2. The cache controller 32 inquires of the content management portion 33 to acquire the content (at steps S4_3-S4_5).
3. The cache controller 32 instructs the cache server information management portion 34 to register the information of the cache server 2 (at steps S5_1-S5_3). At this time, the attribute is also registered.
4. The cache controller 32 generates the content synchronization response by using the acquired content (at step S6_1 see FIG. 16) to be transferred to the communication management portion 31.
5. The communication management portion 31 transmits the content synchronization response to the requested source (at step S6_2).
   (2) Operation Example of Content Server when having Detected the Cache Update By the Content Server (Operation Upon Cache Update in Which A Content Server Takes An Initiative) FIGS. 29 And 5 (One-Dot Chain Line Portion (2))
1. When detecting the cache update (at step S21_1), the cache server information management portion 34 transfers the cache notification request to the cache controller 32 (at step S22).
2. The cache controller 32 inquires of the content management portion 33 to acquire the content (at steps S21_3-S21_5).
3. The cache controller 32 instructs the cache server information management portion 34 to update the cache server information including the unique information and the attribute of the content (at steps S21_6-S21_8).
4. The cache controller 32 generates the cache notification by using the acquired content (at step S22_1 see FIG. 22) to be transferred to the communication management portion 31.
5. The communication management portion 31 transmits the cache notification to the requested source (at step S22_2).
   (3) Operation Example of Content Server when having Received A Cache Notification Response (Operation upon Cache Update in Which A Content Server Takes an Initiative) FIGS. 30 And 5 (One-Dot Chain Line Portion (3))
1. When Receiving the Cache Notification Response (See FIG. 23) from the Cache Server 2 (At Step S25_1), the Communication Management Portion 31 Transfers the Request to the Cache Controller 32 (At Step S25_2).
2. The cache controller 32 instructs the cache server information management portion 34 to update the cache server information including the unique information and the attribute of the content (at steps S26_1-S26_3).
   (4) Operation Example of Content Server when Having Detected that Content has Become Available which was Temporarily Unavailable by the Content Server FIGS. 31 and 8 (One-Dot Chain Line Portion (4))
1. When autonomously detecting the content update (at step S41_1), the content management portion 33 notifies the content update to the cache server information management portion 34 (at step S41_2).
2. When the cache server information management portion 34 detects the cache update by using the notified information (at step S41_3), the cache server information management portion 34 transfers the cache notification request to the cache controller 32 (at step S41_4).
3. The cache controller 32 inquires of the content management portion 33 to acquire the content (at steps S41_5-S41_7).
4. The cache controller 32 instructs the cache server information management portion 34 to update the cache server information including the unique information and the attribute of the content (at steps S41_8-S41_10).
5. The cache controller 32 generates the cache notification by using the acquired content (at step S42_1 see FIG. 22) to be transferred to the communication management portion 31.
6. The communication management portion 31 transmits the cache notification to a predetermined cache server (at step S42_2).

### Operation Example of Client

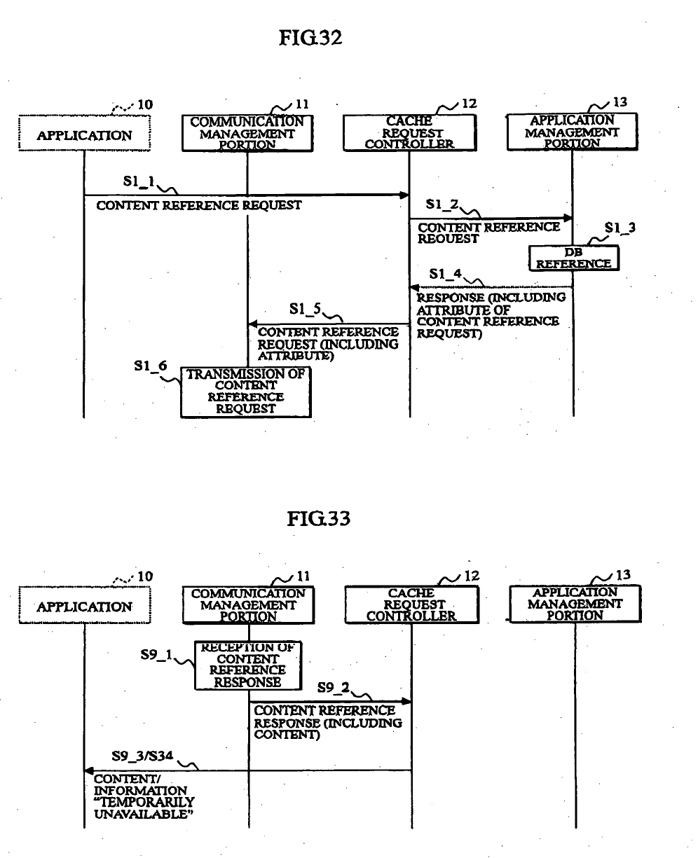

(1) Operation Example of Client when having Transmitted Content Reference Request FIGS. 32 and 2 (Two-Dot Chain Line Portion (1))

1. An application 10 transfers the content reference request to the cache request controller 12 (at step S1_1).
2. The cache request controller 12 acquires an attribute required for the application 10 by referring to the application management portion 13 (at steps S1_2-S1_4).
3. The cache request controller 12 further generates the content reference request by using the acquired attribute (at step S1_5 see FIG. 13) to be transferred to the communication management portion 11.
4. The communication management portion 11 transmits the content reference request to the cache server 2 (at step S1_6).
   (2) Operation Example of Client when having Received a Content Reference Response FIGS. 33. 2, and 7 (Two-Dot Chain Line Portion (2))
1. When receiving the content reference response (see FIG. 17) including the content (at step S9_1), the communication management portion 11 transfers the content reference response to the cache request controller 12 (at step S9_2).
2. The cache request controller 12 transfers the content included in the transferred response (see FIG. 2) or the information indicating that the content is temporarily unavailable (see FIG. 7), to the application 10 (at step S9_3 or S34).

It is to be noted that the present invention is not limited by the above-mentioned embodiments, and that various modifications may be obviously made by one skilled in the art based on the recitation of the claims.

What is claimed is

1. A content retrieval system comprising
a client generating a content reference request including unique information and an attribute of a desired content; and
a cache server checking, based on the content reference request from the client, a presence/absence of a cache of the content, transmitting to a content server a content synchronization request including the unique information and the attribute in the absence of the cache of the content, caching the content when the content is transmitted from the content server having received the content synchronization request, and performing synchronization mirroring with the content server based on the attribute after the cache server has transmitted the content to the client.

2. The content retrieval system as claimed in claim 1, wherein in the presence of the cache of the content, the cache server performs the synchronization mirroring with the content server based on the attribute after the cache server has transmitted the content held to the client.

3. The content retrieval system as claimed in claim 1, wherein for the synchronization mirroring, the cache server takes an initiative to detect a cache update based on the attribute and requests the cache update from the content server.

4. The content retrieval system as claimed in claim 2, wherein for the synchronization mirroring, the content server takes an initiative to detect a cache update based on the attribute and requests the cache update by transmitting a cache notification including the content to the cache server.

5. A content retrieval system comprising
a client generating a content reference request including unique information and an attribute of a desired content; and
a cache server checking, based on the content reference request from the client, a presence/absence of a cache of the content, transmitting to a content server a content synchronization request including the unique information and the attribute in the absence the cache of the content, and transmitting to the client a content reference response that the content is temporarily unavailable when the cache server receives a content synchronization response that the content is temporarily unavailable from the content server having received the content synchronization request.

6. A content retrieval system comprising
a client generating a content reference request including unique information and an attribute of a desired content; and
a cache server checking, based on the content reference request from the client, a presence/absence of a cache of the content, checking information of a content server held by the cache server itself in the absence of the cache of the content, and transmitting to the client, when the content server has found that the content is temporarily unavailable, a content reference response indicating that the content is temporarily unavailable.

7. The content retrieval system as claimed in claim 5, wherein when the content becomes available, the content server requests a cache update by transmitting a cache notification including the content to the cache server.

8. The content retrieval system as claimed in claim 1, wherein the cache server updates information on the content server every time the cache server receives the information from the content server, and the content server updates information on the cache server every time the content server receives the information from the cache server.

9. The content retrieval system as claimed in claim 1, wherein the attribute comprises a lifetime of a cache and a reference desired interval thereof.

10. The content retrieval system as claimed in claim 2, wherein the cache server updates information on the content server every time the cache server receives the information from the content server, and the content server updates information on the cache server every time the content server receives the information from the cache server.

11. The content retrieval system as claimed in claim 3, wherein the cache server updates information on the content server every time the cache server receives the information from the content server, and the content server updates information on the cache server every time the content server receives the information from the cache server.

12. The content retrieval system as claimed in claim 4, wherein the cache server updates information on the content server every time the cache server receives the information from the content server, and the content server updates information on the cache server every time the content server receives the information from the cache server.

13. The content retrieval system as claimed in claim 5, wherein the cache server updates information on the content server every time the cache server receives the information from the content server, and the content server updates information on the cache server every time the content server receives the information from the cache server.

14. The content retrieval system as claimed in claim 6, wherein the cache server updates information on the content server every time the cache server receives the information from the content server, and the content server updates information on the cache server every time the content server receives the information from the cache server.

15. The content retrieval system as claimed in claim 7, wherein the cache server updates information on the content server every time the cache server receives the information from the content server, and the content server updates information on the cache server every time the content server receives the information from the cache server.

16. The content retrieval system as claimed in claim 2, wherein the attribute comprises a lifetime of a cache and a reference desired interval thereof.

17. The content retrieval system as claimed in claim 3, wherein the attribute comprises a lifetime of a cache and a reference desired interval thereof.

18. The content retrieval system as claimed in claim 4, wherein the attribute comprises a lifetime of a cache and a reference desired interval thereof.

19. The content retrieval system as claimed in claim 5, wherein the attribute comprises a lifetime of a cache and a reference desired interval thereof.

20. The content retrieval system as claimed in claim 6, wherein the attribute comprises a lifetime of a cache and a reference desired interval thereof.
